(19) United States
(12) Patent Application Publication
(10) Pub. No.: US 2004/0090392 A1
(43) Pub. Date: May 13, 2004

(54) Image transmission system

(76) Inventors: Kun-Huei Chen, Taipei Hsien (TW); Kuo-Hsuan Luo, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,654

(22) Filed: Nov. 7, 2002

(51) Int. Cl. G09G 5/00; G09G 3/00

(52) U.S. Cl. 345/2.3

(57) ABSTRACT

An image transmission system includes a computer for generating image signals and an image-projecting device having a receiver and an image-projecting module. The computer includes a transmitter for wirelessly outputting the image signals. The receiver is used for receiving the image signals outputted by the computer. The image-projecting module includes an image-generating module and a lens set. The image-generating module is used for transforming the image signals received by the receiver to corresponding images. The lens set is used for projecting the corresponding images generated by the image-generating module onto a screen.

### BACKGROUND OF INVENTION

1. Field of the Invention

The present invention relates to an image transmission system, and more particularly, to an image transmission system capable of wirelessly transmitting image signals generated by a computer to an image-projecting device.

2. Description of the Prior Art

In recent years, the explosive development of electronic technologies has made a computer a very popular tool for storing and for processing data. Data stored in the computer can be displayed on a monitor. The data displayed on the monitor can also be simultaneously displayed on a screen by connecting the computer to an image-projecting device through a transmission line and then by projecting image signals transmitted by the computer and received by the image-projecting device onto the screen with the image-projecting device. The image signals are transformed from the data displayed on the monitor by the computer. Thus, more people can simultaneously read the data just displayed on the monitor.

Please refer to FIG. 1, which is a schematic diagram of an image transmission system 10 according to the prior art. The image transmission system 10 comprises a computer 12 for storing and processing data, a monitor 14 for displaying data stored in the computer 12, a transmission line 16 connected to the computer 12 for transmitting image signals generated by the computer 12, a screen 18, and an image-projecting device 20 connected to the transmission line 16 for projecting the image signals transmitted via the transmission line 16 onto the screen 18.

The computer 12 can transmit the image signals, generated from data displayed on the monitor 14 by the computer 12, to the image-projecting device 20 through the transmission line 16. After receiving the image signals, the image-projecting device 20 can project the image signals onto the screen 18. Thus, more people can simultaneously read (or watch) the data just displayed on the monitor 14.

In the prior art image transmission system 10, because the computer 12 cannot transmit image signals to the image-projecting device 20 without the transmission line 16, if the transmission line 16 is disconnected from the computer 12 or from the image-projecting device 20 because of carelessness of a reckless person, the image signals shown onto the screen 18 will simultaneously disappear. Additionally, the disposition of the computer 12 and the image-projecting device 20 is restricted by the length of the transmission line 16. Furthermore, if the image transmission system 10 comprises more than one computer, the image transmission system 10 needs more transmission lines, corresponding to more complicated layout, to connect the image-projecting device 20 to corresponding computers to serve as image signal transmission channels between the image-projecting device 20 and the computers.

### SUMMARY OF INVENTION

It is therefore a primary objective of the claimed invention to provide an image transmission system capable of wirelessly transmitting image signals to an image-projecting device to solve the above-mentioned problems.

According to the claimed invention, the image transmission system comprises an image-projecting device and a computer for generating an image signal. The computer comprises a transmitter for wirelessly transmitting the image signal. The image-projecting device comprises a projecting module and a receiver for receiving the image signal and transforming the image signal into a first signal. The receiver comprises an image-generating module for transforming the first signal into a corresponding image, and a lens set for projecting the corresponding image onto a screen.

It is an advantage of the claimed invention that the computer and the image-projecting device can be disposed anywhere in the area of the image transmission system.

It is another advantage of the claimed invention that the image transmission system 30 can accommodate more than one computer to simultaneously transmit image signals to the image-projecting device 34 without complicating the “layout” of the image transmission system 30.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of an image transmission system according to the prior art.

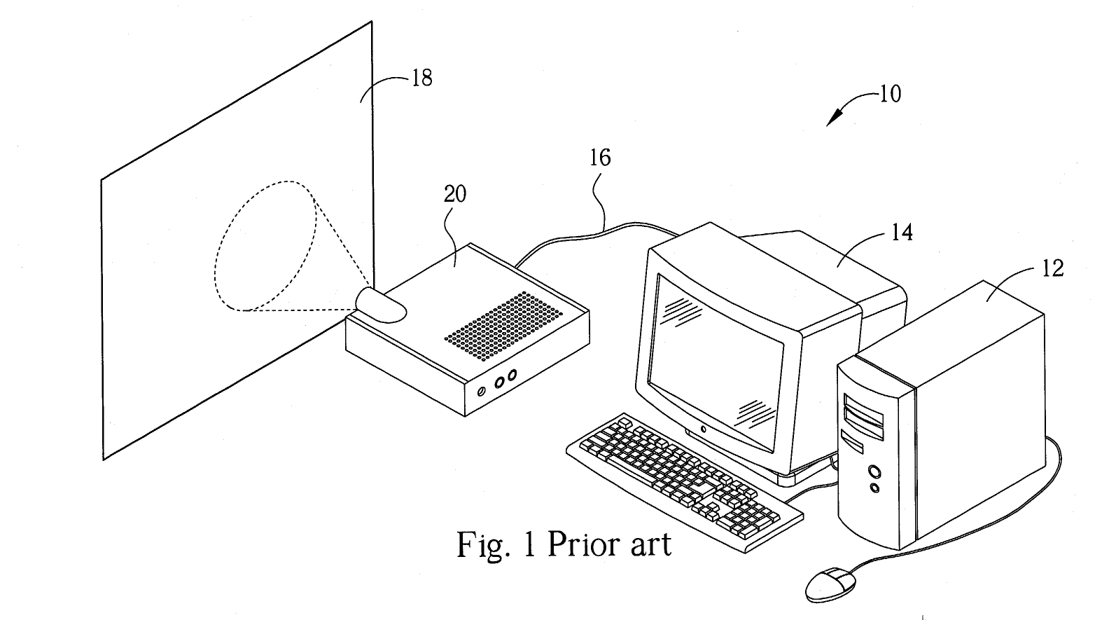

FIG. 2 is a function block diagram of an image transmission system according to the present invention.

### DETAILED DESCRIPTION

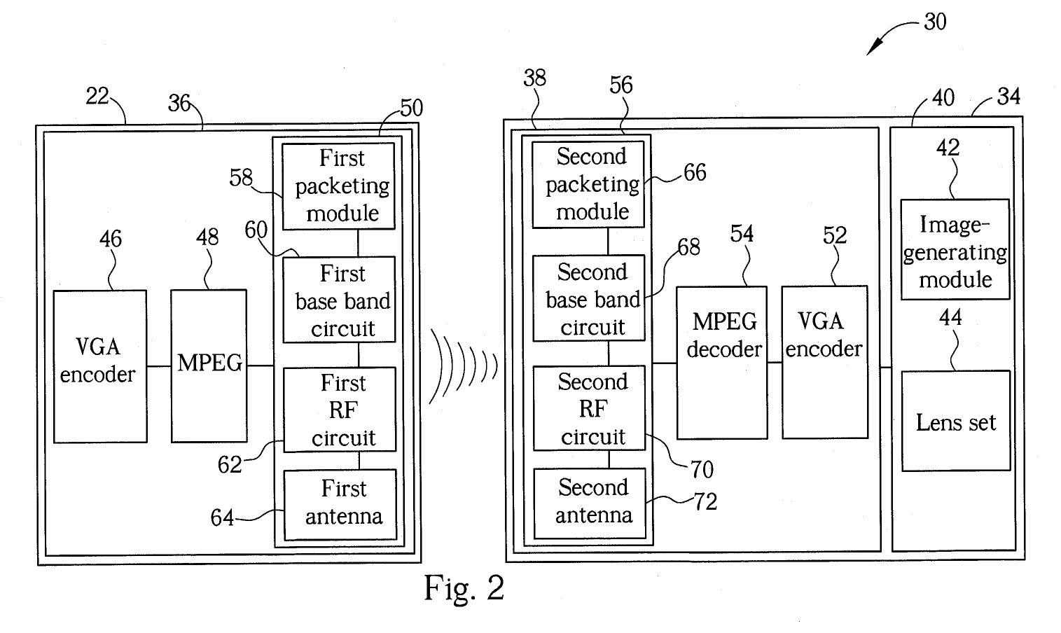

Please refer to FIG. 2, which is a function block diagram of an image transmission system 30 according to the present invention. The image transmission system 30 comprises an image-projecting device 34 and a computer 32 for generating image signals. The computer 32 comprises a transmitter 36 for wirelessly transmitting the image signals. The image-projecting device 34 comprises an image-projecting module 40 and a receiver 38 for receiving the image signals transmitted by the transmitter 36 of the computer 32. The image-projecting module 40 comprises an image-generating module 42 for transforming the image signals received by the receiver 38 into corresponding images. The image-projecting module 40 further comprises a lens set 44 for projecting the corresponding images transformed by the image-generating module 42 onto a screen (not shown).

Contrary to the prior art image transmission system 10, the image transmission system 30 transmits image signals with the transmitter 36 to the image-projecting device 34 in a wireless manner. After receiving the image signals with the receiver 38, the image-projecting device 34 transforms the image signals with the image-generating module 42 of the image-projecting module 40 into corresponding images and then projects the corresponding images onto the screen with the lens set 44 of the image-projecting module 40.

In the preferred embodiment of the present invention shown in FIG. 2, the transmitter 36 and the receiver 38 are respectively embedded in the computer 32 and in the image-projecting device 34. The transmitter 36 and the receiver 38 can also be designed as two independent wireless communications modules respectively connected to an individual video graphic array (VGA) terminal of the computer 32 and of the image-projecting device 34. In such a case the transmitter 36 and the receiver 38 can combine to form an image transmission set and can transmit image signals generated by a computer to any kind of image-projecting devices.

Image signals generated by the computer 32 cannot be wirelessly transmitted to the image-projecting device 34 until the image signals has been encoded, compressed, and modulated. Likewise, image signals received by the image-projecting device 34 cannot be projected onto the screen without being processed in advance. Please refer to FIG. 2 again. The transmitter 36 comprises a VGA encoder 46, a motion picture experts group (MPEG) compressor 48, and a first wireless network module 50. The VGA encoder 46 is used to transform a first analog VGA signal generated by the computer 32 into a first digital VGA signal. The MPEG compressor 48 is used to compress the first digital VGA signal into a first compressed VGA signal. The first wireless network module 50 is used to transform the first compressed VGA signal into an image signal and to wirelessly transmit the image signal to the receiver 38 of the image-projecting device 34.

In FIG. 2, the receiver 38 comprises a VGA decoder 52, an MPEG decompressor 54, and a second wireless network module 56. The second wireless network module 56 is used to transform the image signal received by the receiver 38 into a second compressed VGA signal. The MPEG decompressor 54 is used to decompress the second compressed VGA signal into a second digital VGA signal. The VGA decoder 52 is used to decode the second digital VGA signal into a second analog VGA signal and to transmit the second analog VGA signal to the image-projecting module 40.

Please refer to FIG. 2 again. The first wireless network module 50 of the transmitter 36 comprises a first packeting module 58, a first base band circuit 60, a first radio frequency (RF) circuit 62, and a first antenna 64. The first packeting module 58 is used to transform the first compressed VGA signal generated by the MPEG compressor 48 into a first frame signal in a bit stream format. The first base band circuit 60 is used to transform the first frame signal into a first base band signal. The RF circuit 62 is used to modulate the first base band signal into an image signal. The first antenna 64 is used to wirelessly transmit the image signal to the receiver 38 of the image-projecting device 34.

Similar to the transmitter 36, the receiver 38 shown in FIG. 2 also comprises a second packeting module 66, a second base band circuit 68, a second RF circuit 70, and a second antenna 72. The second antenna 72 is used to receive the image signal transmitted by the first antenna 64 of the first wireless network module 50 of the transmitter 36. The second RF circuit 70 is used to demodulate the image signal into a second base band signal. The second base band circuit 68 is used to transform the second base band signal into a second frame signal in the bit stream format. The second packeting module 66 is used to transform the second frame signal into a second compressed VGA signal and to transmit the second compressed VGA signal to the MPEG decompressor 54.

The above-mentioned first frame signal and the second frame signal both conform to the IEEE 802.11 standard. That is, the first frame signal (the second frame signal also) comprises a header sector, a data sector, and a frame check sequence (FCS) sector. The header sector comprises a preamble, a start frame delimiter (SFD) for identifying sources of data of the first frame signal, a hardware address, and other related data. The FCS is used to identify allocations of bits of the first frame signal. The first packeting module 58 of the first wireless network module 50 establishes the header sector and the FCS sector according to a common protocol to guarantee that the computer 32 and the image-projecting device 34 in the image transmission system 30 are compatible.

The image transmission system 30 shown in FIG. 2 comprises only one computer that is the computer 32, yet the image transmission system 30 can comprise a plurality of computers. Respectively equipped with the transmitter 36, the plurality of computers are capable of simultaneously transmitting image signals to the receiver 38 of the image-projecting device 34 under consideration of a carrier sense multiple access collision detection (CSMA/CD) problem.

In contrast to the prior art image transmission system 10, the present invention has at least following advantages:

1. In the image transmission system 30, the computer 32 transmits image signals to the image-projecting 34 in a wireless manner, so the computer 32 and the image-projecting device 34 can be disposed anywhere in the area of the image transmission system 30;

2. The image transmission system 30 can accommodate more than one computer to simultaneously transmit image signals to the image-projecting device 34 without complicating the “layout” of the image transmission system 30;

3. The transmitter 36 and the receiver 38 of the image transmission system 30 are both designed according to the IEEE 802 standard, so no matter what operating system the computer 32 adopts to generate image signals, the image signals are always compatible to the MAC layer standard of the image transmission system 30. Additionally, the wireless image signals will not interfere other wireless signals transmitted over a local area network; and

4. Because the transmitter 36 and the receiver 38 can also be externally connected, not just be respectively embedded in the computer 32 and in the image-projecting device 34, to a computer and to an image-projecting device, the image transmission system 30 can be applied to each kind of computers and image-projecting devices.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. An image transmission system comprising:
a computer for generating an image signal, the computer comprising a transmitter for wirelessly transmitting the image signal; and
an image-projecting device comprising:
a receiver for receiving the image signal and transforming the image signal into a first signal; and
a projecting module comprising:
an image-generating module for transforming the first signal into a corresponding image; and
a lens set for projecting the corresponding image onto a screen.

2. The image transmission system of claim 1 wherein the transmitter comprises a first wireless communications module for wirelessly transmitting the image signal, and the receiver comprises a second wireless communications module for receiving the image signal transmitted by the first wireless communications module of the transmitter.

3. The image transmission system of claim 1 wherein the transmitter comprises a video graphic array (VGA) encoder, a motion picture experts group compressor (MPEG compressor), and a first wireless network module, the first wireless network module being used to transform a first compressed VGA signal into the image signal, the MPEG compressor being used to compress a first digital VGA signal into the first compressed VGA signal, and the VGA encoder being used to generate the first digital VGA signal.

4. The image-transmission system of claim 3 wherein the first wireless network module comprises a first packeting module, a first base band circuit, and a first radio frequency circuit, the first packeting module being used to transform the first compressed VGA signal into a first frame signal, the first base band circuit being used to transform the first frame signal into a first base band signal, and the first radio frequency circuit being used to modulate the first base band signal into the image signal.

5. The image transmission system of claim 4 wherein the first frame signal conforms to the IEEE 802.11 standard.

6. The image transmission system of claim 1 wherein the image signal conforms to the IEEE 802.11 standard.

7. The image transmission system of claim 1 wherein the receiver comprises a VGA decoder, an MPEG decompressor, and a second wireless network module, the second wireless network module being used to transform the image signal into a second compressed signal, the MPEG decompressor being used to decompress the second compressed signal into a second digital VGA signal, and the VGA decoder being used to decode the second digital VGA signal into the first signal.

8. The image transmission system of claim 7 wherein the second wireless network module comprises a second packeting module, a second base band circuit, and a second radio frequency circuit, the second radio frequency circuit being used to demodulate the image signal into a second base band signal, the second base band circuit being used to transform the second base band signal into a second frame signal, and the second packeting module being used to transform the second frame signal into the second compressed VGA signal.

9. The image transmission system of claim 8 wherein the second frame signal conforms to the IEEE 802.11 standard.
